(19) United States
(12) Patent Application Publication
(10) Pub. No.: US 2007/0115891 A1
(43) Pub. Date: May 24, 2007

(54) Method and system for transmitting/receiving data in a communication system

(75) Inventor: Gwang-Eun Kim, Seoul (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd.

(21) Appl. No.: 11/603,770

(22) Filed: Nov. 22, 2006

(30) Foreign Application Priority Data
Nov. 24, 2005 (KR) 113138/2005

(51) Int. Cl. H04Q 7/00

(52) U.S. Cl. 370/332

(57) ABSTRACT

A method is provided for transmitting/receiving data in a communication system. If a base station has data to transmit to a mobile station, the base station detects a service flow for transmission of the data, sets an identifier of the detected service flow in a message, and transmits the message to the mobile station. The base station performs a specific operation of the service flow with the mobile station according to the transmitted message, and transmits the data to the mobile station.

### PRIORITY

This application claims the benefit under 35 U.S.C. § 119(a) of an application filed in the Korean Intellectual Property Office on Nov. 24, 2005 and assigned Serial No. 2005-113138, the contents of which are incorporated herein by reference.

### BACKGROUND OF THE INVENTION

1. Field of the Invention

The present invention relates generally to a communication system, and in particular, to a method and system for transmitting/receiving data by paging a service flow to provide a service to a user.

2. Description of the Related Art

Active research on the next generation communication system is being conducted to provide users with services having various high-speed Qualities of Service (QoS). In particular, a study is now being carried out on the next generation communication system for supporting high-speed services by guaranteeing mobility and QoS for a Broadband Wireless Access (BWA) communication system such as a Local Area Network (LAN) system and a Metropolitan Area Network (MAN) system. Conventional BWA communication systems are the Institute of Electrical and Electronics Engineers (IEEE) 802.16a/d communication system and the IEEE 802.16e communication system.

The IEEE 802.16a/d communication system and the IEEE 802.16e communication system employ Orthogonal Frequency Division Multiplexing (OFDM)/Orthogonal Frequency Division Multiple Access (OFDMA) to support a broadband transmission network for physical channels of the WMAN system. Presently, the IEEE 802.16a/d communication systems consider only the state in which a Subscriber Station (SS) is fixed (i.e. the state in which the SS is mobile is not considered), and the single-cell structure. However, the IEEE 802.16e communication system considers mobility of the SS for the IEEE 802.16a communication system. The SS having mobility will be referred to as a “Mobile Station (MS).”

Because the IEEE 802.16e communication system considers mobility of the MS, power consumption of the MS is an important factor of the system performance. Therefore, an idle mode operation between an MS and a Base Station (BS) for minimizing power consumption of the MS, and an active mode operation corresponding to the idle mode operation have been proposed. The idle mode has been proposed to minimize power consumption of the MS in an idle interval where no packet data is transmitted during packet data transmission. The MS and the BS simultaneously transition to the idle mode thereby minimizing power consumption of the MS in the idle interval where no packet data is transmitted.

Generally, the packet data occurs in a burst manner, so it is unreasonable that the MS operates in the same manner as when the packet data is in the transmission or non-transmission interval, hence the impetus for proposal of the idle mode. However, if transmission of packet data occurs while the BS and the MS are in the idle mode, the BS and the MS both should transition to the active mode simultaneously to exchange the packet data. The operation of the idle mode is proposed not only for the reduction in the power consumption but also for minimization of interference between channel signals. However, because the characteristic of the packet data is greatly affected by the traffic, the idle mode operation should be performed organically considering the traffic characteristic and transmission method of the packet data.

In order for an MS to receive a service from its serving BS in the BWA communication system, the MS should successfully perform a network entry process and establish a service flow with the BS. The term “service flow” refers to a unidirectional flow of Service Data Units (SDUs) delivered through a connection that guarantees a particular QoS. The service flow can have three types of QoS parameter sets of a Provisioned QoS Parameter Set, an Admitted QoS Parameter Set and an Active QoS Parameter Set.

The Provisioned QoS Parameter Set represents the state in which a service flow characteristic is established and a Service Flow Identifier (SFID) is assigned. The SFID is a 32-bit ID that the BS has assigned to the service flow. Logically, the MS has several connections and service flows with the BS, and has a different connection for each service flow. In order to distinguish the different service flows and connections, the SFIDs and Connection Identifiers (CIDs) are used. The Admitted QoS Parameter Set represents the state in which the MS occupies resources but is not activated. In this state, the MS is allocated a 16-bit CID from the BS. The Active QoS Parameter Set represents the state in which the MS actually uses the resources and data is transmitted and received.

If registration of the MS is completed through initialization, a Dynamic Service Addition (DSA) message is exchanged between the MS and the BS. Because the DSA message includes the Provisioned QoS Parameter Set, the MS can establish an available service flow from the BS. For example, the IEEE 802.16e communication system supports such service types as an Unsolicited Granted Service (UGS)type, a real time Polling Service (rtPS)type, a non-real time Polling Service (nrtPS) type and a Best Effort Service (BES)type. Such service types are determined depending on a value of Scheduling Type in a DSA Type/Length/Value (TLV) field.

If the MS changes a service parameter of the currently established service flow while exchanging traffics, the MS transmits a Dynamic Service Change (DSC) message to the BS to change the necessary service parameter, thereby performing a DSC process. In addition, if the MS returns a Transport CID (TCID) in the absence of the traffic, the MS performs the DSC process. If the MS ends the connected service flow after completion of traffic exchange, the MS transmits a Dynamic Service Deletion (DSD) message to the BS, thereby performing a DSD process.

The BWA communication system has a plurality of service flows corresponding to the QoS parameter sets. If there is no traffic while the MS is providing a service to the user, i.e. exchanging packet data with the BS, through the plurality of service flows in the active mode, the MS performs a de-registration process and changes the operation mode from the active mode to the idle mode. In addition, if the MS has a service to provide to the user while performing an operation in the idle mode, the MS transitions to the active mode through a Mobile_Paging-Advertisement (MOB_PAG-ADV) message, which is a broadcasting message that the BS broadcasts to all MSs located in its cell. The BS uses a Media Access Control (MAC) Address hash value of a corresponding MS among the MSs receiving the MOB_PAG-ADV message to inform the MS whether the MS will transition from the idle mode to the active mode.

If the BS sends the paging message to the MS to provide a particular service to the user, the MS should change all service flows determined by the QoS parameter sets from the idle mode to the active mode for the particular service flow. Then the MS performs an operation for each service flow and provides the service to the user. Although it is possible to change the operation mode from the idle mode to the active mode through the MOB_PAG-ADV message for each individual MS, it is impossible to transition from the idle mode to the active mode for each individual service flow.

For example, when the communication system provides a service to the user through 5 different types of service flows each having QoS parameter sets of ‘a’, ‘b’, ‘c’, ‘d’ and ‘e’, if there is no traffic to be exchanged between the BS and the MS, the MS changes its operation mode to the idle mode. If paging occurs in a particular service flow, for example, a service flow having the ‘a’ QoS parameter set, the MS changes all of the 5 types of service flows to the active mode. Thereafter, the MS performs the service only in the service flows having the ‘a’ QoS parameter set, and does not perform the service in the remaining service flows where only the resources are allocated.

That is, because it is impossible to change the operation mode from the idle mode to the active mode through the MOB_PAG-ADV message for each individual service flow of the MS, there occurs an unnecessary waste of resources and frequency bands in the uplink due to a scheduling operation. This waste of resources is particularly prevalent in the UGS type and the rtPS type among the aforementioned service types.

### SUMMARY OF THE INVENTION

It is, therefore, an object of the present invention to provide a method and system for transmitting/receiving data in a communication system.

It is another object of the present invention to provide a method and system for transmitting/receiving data by paging a service flow to provide a service to a user in a communication system.

According to the present invention, there is provided a method for transmitting/receiving data in a communication system. The method includes detecting a service flow for transmission of data if a base station has data to transmit to a mobile station, setting an identifier of the detected service flow in a message and transmitting the message to the mobile station, and performing a specific operation of the service flow with the mobile station according to the transmitted message, and transmitting the data to the mobile station.

According to the present invention, there is provided a system for transmitting/receiving data in a communication system. The system includes a base station for detecting a service flow for transmission of data if there is data to exchange with a mobile station, setting in a message an identifier of the detected service flow, transmitting the message to the mobile station, performing a paging operation of the service flow with the mobile station according to the transmitted message and transmitting the data to the mobile station, and the mobile station for receiving the message used for transmission of the data from the base station, performing a specific operation of the service flow with the base station according to the received message and receiving the data.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a signal transmission/reception flow between an MS and a BS in response to a service flow paging in a communication system according to the present invention;

FIG. 2 is a flowchart illustrating an operation of a BS in a communication system according to the present invention; and

FIG. 3 is a flowchart illustrating an operation of an MS in a communication system according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

The present invention provides a method and system for transmitting/receiving data by paging a service flow in an communication system, for example, Institute of Electrical and Electronics Engineers (IEEE) 802.16 communication system as a Broadband Wireless Access (BWA) communication system. The BWA communication system has a plurality of service flows depending on various Quality-of-Service (QoS) parameter sets, and in the present invention data is transmitted/received after paging a specific service flow among the plurality of service flows to provide a specific service to the user. Although the present invention will be described with reference to the IEEE 802.16 communication system, the data transmission/reception method and system provided in the present invention can also be applied to other communication systems.

Further, the present invention provides a scheme in which a base station (BS) pages a specific service flow to a user through a mobile station (MS) existing in an idle mode in the BWA communication system, i.e. provides a method and system for changing an operation mode of the MS from an idle mode to an active mode. In addition, the present invention provides a method and system for providing a service to the user by changing a service flow mode while providing the service to the user through a specific service flow existing in the active mode to the user in the BWA communication system.

In the present invention, the MS is both fixed and mobile, and if the MS has no traffic while providing a service to the user, i.e. while exchanging packet data with its serving BS, the MS transitions from the active mode to the idle mode to reduce power consumption. If the MS has a service to provide to the user in the idle mode, the MS receives a Mobile_Paging-Advertisement (MOB_PAG-ADV) message from the BS and transitions from the idle mode to the active mode.

The MOB_PAG-ADV message according to the present invention is a broadcasting message that the BS broadcasts to all MSs located in its cell. The BS transmitting the MOB_PAG-ADV message includes in the MOB_PAG-ADV message a Media Access Control (MAC) address of a corresponding MS among the MSs receiving the MOB_PAG-ADV message to inform the MS whether the MS will transition from the idle mode to the active mode, and a Service Flow Identifier (SFID) for informing the corresponding MS which service flow the BS will page among the service flows.

Therefore, if the MS pages a specific service flow to provide a specific service to the user, the BS includes in the MOB_PAG-ADV message the value generated by combining the SFID of the specific service flow and the MAC address of the MS so as to perform paging according to the specific service flow, or includes in the MOB_PAG-ADV message a MAC Address hash value of the MS and the SFID of the specific service flow or the SFID hash value, and then transmits the MOB_PAG-ADV message to the MS.

Upon receipt of the MOB_PAG-ADV message, the MS checks a MAC address and an SFID included in the received MOB_PAG-ADV message to determine whether the BS has performed paging to the MS itself and to recognize a service flow to be paged, and transitions to the active mode thereby providing the service to the user. In other words, upon receiving the MOB_PAG-ADV message from the BS, the MS determines whether it will transition from the idle mode to the active mode, recognizes the service flow to be changed from the idle mode to the active mode, and changes only the recognized service flow from the idle mode to the active mode thereby providing the service to the user.

Herein, the service flow can have three types of QoS parameter sets of a Provisioned QoS Parameter Set, an Admitted QoS Parameter Set and an Active QoS Parameter Set.

The Provisioned QoS Parameter Set represents the state in which a service flow characteristic is established and an SFID is assigned. The SFID is a 32-bit ID that the BS has assigned to the service flow. Logically, the MS has several connections and service flows with the BS, and has a different connection for each service flow. In order to distinguish the different service flows and connections, the SFIDs and Connection Identifiers (CIDs) are used. The Admitted QoS Parameter Set represents the state in which the MS occupies resources but is not activated. In this state, the MS is allocated a 16-bit CID from the BS. The Active QoS Parameter Set represents the state in which the MS actually uses the resources. In this state, data can be actually transmitted and received.

If registration of the MS is completed through initialization, the MS performs a Dynamic Service Addition (DSA) process with the BS and establishes an available service flow from the BS. The BWA communication system supports such service types as an Unsolicited Granted Service (UGS) type, a real time Polling Service (rtPS) type, a non-real time Polling Service (nrtPS) type, and a Best Effort Service (BES) type.

If the MS changes a service parameter of the currently established service flow while providing the service to the user, i.e. while exchanging traffics with the BS, the MS transmits a Dynamic Service Change (DSC) message to the BS to change the necessary QoS parameter, thereby performing a DSC process. If the MS ends the connected service flow after completion of traffic exchange, i.e. if the MS ends the currently established service flow, the MS transmits a Dynamic Service Deletion (DSD) message to the BS, thereby performing a DSD process.

Accordingly, if the BWA communication system changes an operation mode of another service flow while providing a service to the user through a specific service flow existing in the active mode, for example, provides the service to the user additionally using the service flow existing in the current idle mode or provides the service to the user by changing any one of the two or more service flows existing in the active mode to the idle mode, the the present invention exchanges a Dynamic Service X (DSX) message including the DSA message and the DSC message between the BS and the MS, thereby performing the DSA process and the DSC process and providing the service to the user. The DSX message includes an SFID of the service flow that should transition from the idle mode to the active mode, or an SFID of the service flow that should transition from the active mode to the idle mode.

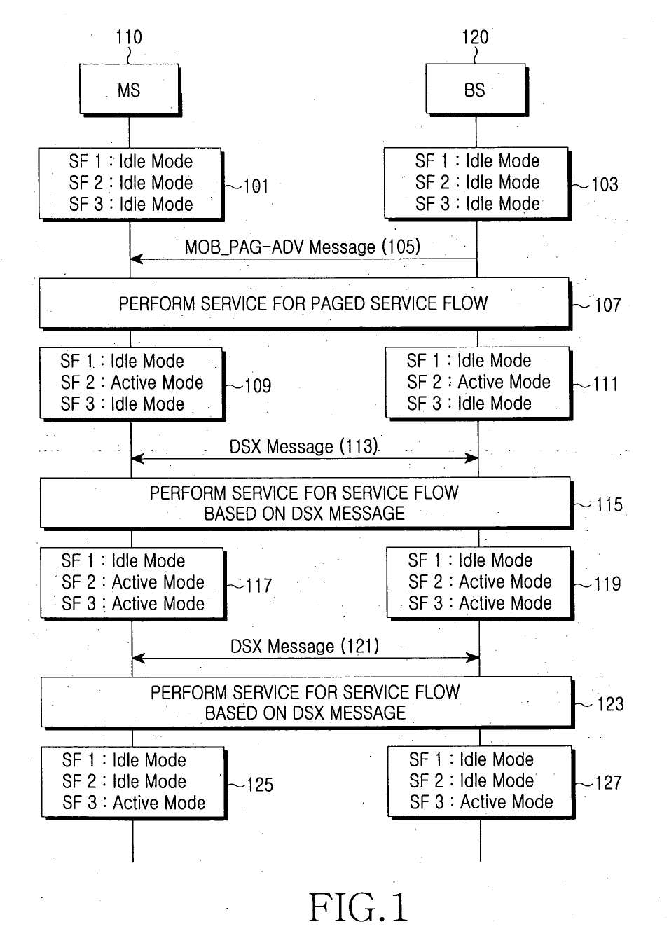

FIG. 1 is a diagram illustrating a signal transmission/reception flow between an MS and a BS in response to a service flow paging in a communication system according to the present invention. For convenience, it is assumed in FIG. 1 that the MS provides a service from the BS to the user through 3 service flows SF1, SF2 and SF3 each having a different QoS parameter set.

Referring to FIG. 1, an MS 110 and a BS 120, as there is no packet data to be exchanged there between, perform a de-registration operation, and change their operation modes from the active mode to the idle mode, so all service flows SF1, SF2 and SF3 of the MS 110 and the BS 120 exist in the idle mode (Steps 101 and 103). While the MS 110 and the BS 120 are performing an operation in the idle mode, if there is a service to provide to the user, i.e. if the BS 120 has packet data to transmit to the MS 110, the BS 120 transmits a MOB_PAG-ADV message to the MS 110 (Step 105).

In other words, if there is packet data used for providing a specific service to the user, the BS 120 transmits to the MS 110 the MOB_PAG-ADV message including an SFID of a specific service flow to be paged for providing the specific service, and a MAC address of the MS 110. That is, the BS 120 includes in the MOB_PAG-ADV message the specific value generated by combining the SFID of the specific service flow and the MAC address of the MS 110 so as to perform paging according to the specific service flow, or includes in the MOB_PAG-ADV message the MAC Address hash value of the MS 110 and the SFID of the specific service flow or the SFID hash value, and then transmits the MOB_PAG-ADV message to the MS 110.

The SFID of the service flow, as described above, is an ID assigned according to characteristic of each service flow, and different SFIDs are assigned for a service flow1 SF1, a service flow2 SF2 and a service flow3 SF3, respectively.

The BS 120 informs the MS 110 that it will provide a service to the user using the service flow2 SF2, i.e. that it will page the service flow2 SF2 among the 3 service flows SF1, SF2 and SF3 and perform packet data exchange with the MS 110. To this end, the BS 120, as described above, transmits to the MS 110 the MOB_PAG-ADV message including the SFID of the service flow2 SF2 and the MAC address of the MS 110 so as to change only the service flow2 SF2 among the 3 service flows SF1, SF2 and SF3 from the idle mode to the active mode.

Only the service flow2 SF2 among the 3 service flows SF1, SF2 and SF3 existing in the idle mode is paged by the MOB_PAG-ADV message, and the MS 110 and the BS 120 perform the DSX process on the paged service flow2 SF2 thereby performing a service procedure of the service flow2 SF2 (Step 107). As a result, only the service flow2 SF2 exists in the active mode, and the other service flows, i.e. the service flow1 SF1 and the service flow3 SF3, exist in the idle mode, so the MS 110 and the BS 120 provide the service to the user through the service flow2 SF2 existing in the active mode (Steps 109 and 111).

While providing the service to the user through the service flow2 SF2 existing in the active mode, if the MS 110 changes to another service flow other than the service flow2 SF2 that is currently established, or paged and currently existing in the active mode, and provides the service to the user, the MS 110 and the BS 120, as described above, exchange DSX messages including the DSA message and the DSC message (Step 113). For convenience, it is assumed herein that the DSX message is provided for providing to the user not only the service flow2 SF2 that is paged and currently existing in the active mode, but also the service flow3 SF3 existing in the idle mode. By exchanging the DSX messages, the MS 110 and the BS 120 perform the DSA process or the DSC process, thereby performing services of the service flow2 SF2 and the service flow#3 SF3 (Step 115).

More specifically, the DSX message includes information indicating that the BS 120 will provide the service of the service flow3 SF3 to the user to provide the service to the user, and after exchanging the DSX message, the MS 110 and the BS 120 perform a process corresponding to the DSX message including the information, thereby performing the services of the service flow2 SF2 and the service flow3 SF3. The DSX message, as described above, includes an SFID of the service flow that should transition from the idle mode to the active mode, or an SFID of the service flow that should transition from the active mode to the idle mode.

As a result, the DSX message includes an SFID of the service flow3 SF3 that should transition from the idle mode to the active mode. After the MS 110 and the BS 120 exchange the DSX message, the service flow2 SF2 and the service flow3 SF3 exist in the active mode and the service flow#1 SF1 exists in the idle mode, and the MS 110 and the BS 120 provide the service to the user through the service flow2 SF2 and the service flow3 SF3 existing in the active mode (Steps 117 and 119).

In addition, while providing the service to the user through the service flow2 SF2 and the service flow3 SF3 existing in the active mode, if the MS 110 provides the service to the user using only the service flow3 SF3, the MS 110 and the BS 120 exchange a DSX message including a DSA message or a DSC message (Step 121). By exchanging the DSX messages, the MS 110 and the BS 120 perform the DSA process or the DSC process, thereby performing the service of the service flow3 SF3 (Step 123).

More specifically, the DSX message includes information indicating that the BS 120 will provide the service to the user using only the service flow3 SF3, and after exchanging the DSX message, the MS 110 and the BS 120 perform a DSA process or a DSC process according to the DSX message including the information, thereby performing the service of the service flow3 SF3. In this case, the DSX message includes an SFID of the service flow2 SF2 that should transition from the active mode to the idle mode.

As a result, the service flow3 SF3 exists in the active mode and the service flow1 SF1 and the service flow2 SF2 exist in the idle mode, and the MS 110 and the BS 120 provide the service to the user through the service flow3 SF3 existing in the active mode (Steps 125 and 127).

In the communication system according to the present invention, paging of the service flow provides a service to the user by exchanging the MOB_PAG-ADV message and the DSX message according to the service flow to be paged as described above. More specifically, while the MS and the BS of the communication system exist in the idle mode in the absence of the traffic there between, i.e. while all service flows exist in the idle mode, if the BS has a service to provide to the user using a specific service flow, the BS transmits to the MS the MOB_PAG-ADV message including an SFID of the specific service and a MAC address of the MS, thereby performing paging. When all service flows exist in the idle mode, if there is data to be exchanged between the MS and the BS, only the specific service flow corresponding to the SFID included in the MOB_PAG-ADV message transitions from the idle mode to the active mode, and the MS and the BS provide the service to the user through the service flow that transitioned to the active mode.

In addition, while providing the service to the user through the specific service flow existing in the active mode, if the communication system changes to another service flow, the MS and the BS perform paging by exchanging the DSX message including the information on the service flow to be changed, i.e. an SFID of the service flow that should transition from the idle mode to the active mode, an SFID of the service flow that should transition from the active mode to the idle mode, and an SFID of the service flow that will not undergo state transition of the operation mode, and provide the service to the user through the service flow that is paged and then existing in the active mode.

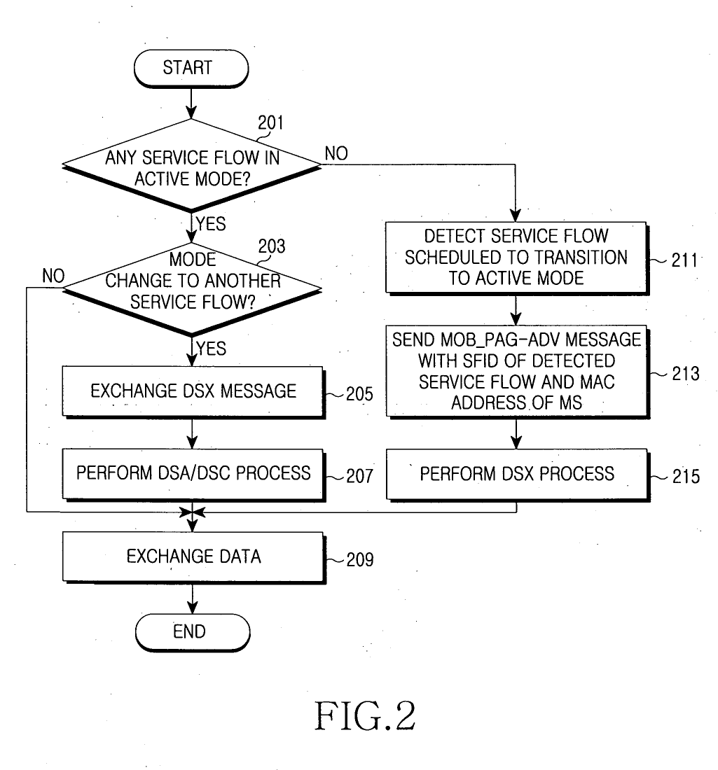

FIG. 2 is a flowchart illustrating an operation of a BS in a communication system according to the present invention.

Referring to FIG. 2, if the BS has a service to provide to a user in step 201, i.e. if the BS has data to transmit to an MS, the BS determines whether there is a paged service flow currently existing in the active mode. If it is determined that there is a service flow currently existing in the active mode, the BS proceeds to step 203 where it changes to another service flow while providing the service to the user through the specific service flow existing in the active mode, and determines whether there is a service to provide to the user through the changed service flow.

If the BS determines to change to another service flow as a result of the determination, the BS exchanges a DSX message including information on the changed service flow with the MS in step 205. The DSX message, as described above, includes an SFID of a service flow that should transition from the idle mode to the active mode, or an SFID of a service flow that should transition from the active mode to the idle mode.

In step 207, the BS performs a service procedure by performing the DSA process or the DSC process according to the information on the service flow included in the DSX message. After changing each of the service flows from the idle mode to the active mode according to the information included in the DSX message in step 207, the BS provides the service to the user by exchanging data with the MS through the service flow existing in the active mode in step 209.

However, if it is determined in step 201 that there is no service flow currently existing in the active mode, i.e. every service flow exists in the idle mode, the BS proceeds to step 211 where it detects a service flow to be paged for providing a specific service to the user, i.e. detects a specific service flow to be changed to the active mode among all service flows existing in the idle mode. In step 213, the BS transmits to the MS a MOB_PAG-ADV message including an SFID of the detected service flow and a MAC address of the MS. In this step, the BS includes in the MOB_PAG-ADV message a specific value generated by combining the SFID of the specific service flow with the MAC address of the MS, or includes in the MOB_PAG-ADV message a MAC Address hash value of the MS and an SFID of the specific service flow or the SFID hash value, and transmits the MOB_PAG-ADV message to the MS.

Thereafter, in step 215, the BS changes the specific service flow existing in the idle mode to the active mode by performing the DSX process with the MS according to the SFID of the specific service flow included in the MOB_PAG-ADV message, and then proceeds to step 209. In step 209, the BS provides the service to the user by exchanging data with the MS through the service flow existing in the active mode.

However, if the BS determines not to change to another service flow in step 203, the BS proceeds to step 209 where it provides the service to the user by exchanging data with the MS using the service flow currently existing in the active mode.

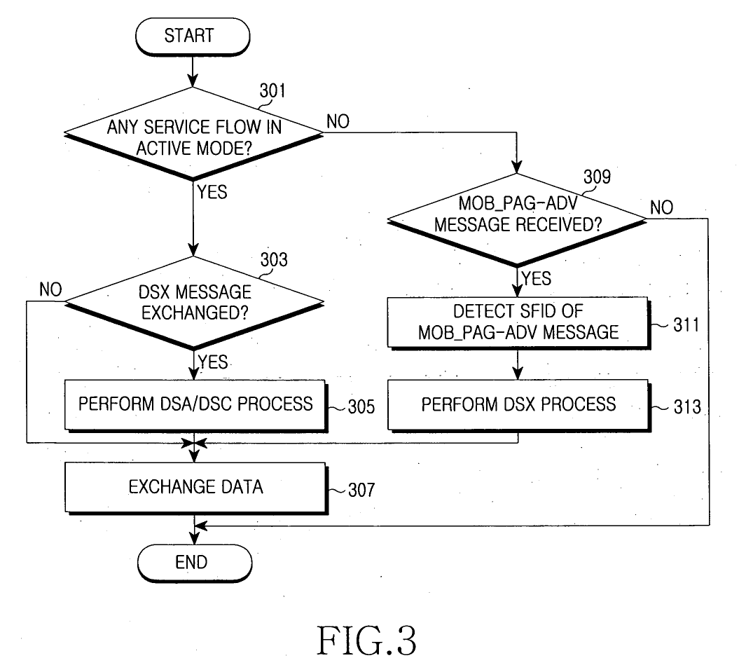

FIG. 3 is a flowchart illustrating an operation of an MS in a communication system according to the present invention.

Referring to FIG. 3, the MS determines in step 301 whether there is a service flow currently existing in the active mode, i.e. whether there is a currently paged service flow. If it is determined that there is a service flow currently existing in the active mode, the MS proceeds to step 303. In step 303, while providing the service to the user through a specific service flow existing in the active mode by detecting the exchange of a DSX message with the BS, the MS changes to another service flow and determines whether it will provide a service to the user through the changed specific service flow. The DSX message, as described above, includes an SFID of a service flow that should transition from the idle mode to the active mode, or an SFID of a service flow that should transition from the active mode to the idle mode.

In step 305, the MS performs a service procedure by performing the DSA process or the DSC process according to the information on the service flow included in the DSX message. In this step, the MS changes each of the service flows from the idle mode to the active mode, or from the active mode to the idle mode, according to the information included in the DSX message, and then provides the service to the user by exchanging data with the BS through the service flow existing in the active mode in step 307.

However, if it is determined in step 301 that there is no service flow currently existing in the active mode, i.e. every service flow exists in the idle mode, the MS determines in step 309 whether a MOB_PAG-ADV message used for paging a service flow to provide a specific service to the user is received. If it is determined that the MOB_PAG-ADV message is received, the MS detects an SFID of a service flow to be paged, included in the MOB_PAG-ADV message, in step 311. In this step, the MS detects a specific service flow scheduled to transition to the active mode among all service flows existing in the idle mode. The MOB_PAG-ADV message, as described above, includes an SFID of the specific service flow to be paged and a MAC address of the MS.

Thereafter, in step 313, the MS performs the DSX process with the BS according to the SFID of the specific service flow included in the MOB_PAG-ADV message to change the specific service flow existing in the idle mode to the active mode, and then proceeds to step 307. In step 307, the MS provides the service to the user by exchanging data with the BS through the service flow existing in the active mode. However, if it is determined in step 309 that the MOB_PAG-ADV message is not received, the MS allows all service flows to exist in the idle mode because there is no service to provide to the user.

A description will now be made of a format of the MOB_PAG-ADV message and the DSX message used for performing paging according to the service flow in the communication system according to the present invention.

The new MOB_PAG-ADV message, as shown in Table 1, has an additional field indicating an SFID of the service flow, as compared with the conventional MOB_PAG-ADV message, and a format of the new MOB_PAG-ADV message will be described in detail hereinbelow. Table 1 shows a format of the conventional MOB_PAG-ADV message, and a description of each field in Table 1 will be omitted herein.

TABLE 1

| | Size | |
|---|---|---|
| Syntax | (bits) | Notes |
| MOB_PAG-ADV_Message_format( ) { | — | — |
| Management Message Type=62 | 8 | — |
| Num_Paging_Group_IDs | 8 | Number of Paging Group IDs in this |
| | | message |
| For(i=0; i<Num_Paging_Group_IDs; i++) { | — | — |
| Paging Group ID | 8 | — |
| } | — | — |
| Num_MACs | 8 | Number of MS MAC addresses |
| For(j=0; j< Num_MACs; j++) { | — | — |
| MS MAC Address hash | 24 | The hash is obtained by computing a |
| | | CRC24 on the MS 48-bit MAC address. |
| | | The polynomial for the calculation is |
| | | 0x1864CFB |
| Action Code | 2 bit | Paging action instruction to MS |
| | | 0b00=No Action Required |
| | | 0b01=Perform Ranging to establish |
| | | location and acknowledge message |
| | | 0b10=Enter Network |
| | | 0b11=reserved |
| Reserved | 6 | — |
| } | — | — |
| padding | variable | Padding bits to ensure octet aligned |
| TLV Encoded Information | variable | TLV specific |
| } | — | — |

The new MOB_PAG-ADV message according to the present invention includes an additional field indicting an SFID of a service flow. To this end, the present invention includes information in the MOB_PAG-ADV message by setting a specific value generated by combining an SFID of the service flow and a MAC address of the MS, or a MAC Address hash value of the MS and an SFID of the service flow or the SFID hash value in a MS MAC Address hash field of Table 1, or includes information in the MOB_PAG-ADV message by additionally setting the above information in a Type/Length/Value (TLV) field of Table 1.

The new DSX message according to the present invention has an additional field indicating mode transition of an SFID, as compared with the general DSX message. The new DSX message includes mode transition information of each service flow in the additional field. To this end, the DSX message includes an SFID of the service flow that should transition from the idle mode to the active mode, and an SFID of the service flow that should transition from the active mode to the idle mode.

As can be understood from the foregoing description, in exchanging data with the user through a specific service flow, the communication system according to the present invention performs paging based on the specific service flow, thereby preventing resource waste and reducing unnecessary operation. By doing so, the present invention contributes to a reduction in power consumption and an increase in system performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting/receiving data in a communication system, the method comprising:
detecting, when a base station has data to transmit to a mobile station, a service flow for transmission of the data, setting an identifier of the detected service flow in a message, and transmitting the message to the mobile station; and
performing a specific operation of the service flow with the mobile station according to the transmitted message, and transmitting the data to the mobile station.

2. The method of claim 1, wherein setting the identifier of the detected service flow in the message comprises further setting in the message a Media Access Control (MAC) address of the mobile station to which the base station will transmit the data.

3. The method of claim 1, wherein detecting the service flow for transmission of the data comprises detecting operation modes of all service flows at a generation time of the data, and detecting a service flow to exist in an active mode for transmission of the data among all the service flows.

4. The method of claim 3, wherein setting the identifier of the detected service flow in the message comprises setting in the message an identifier of a service flow to transition from an idle mode to the active mode for transmission of the data, if all the service flows exist in the idle mode.

5. The method of claim 3, wherein setting the identifier of the detected service flow in the message comprises setting in the message an identifier of a service flow to transition from an idle mode to the active mode, if a portion of the service flows exist in the idle mode and a remainder of the service flows exists in the active mode.

6. The method of claim 3, wherein setting the identifier of the detected service flow in the message comprises setting in the message an identifier of a service flow to transition from the active mode to an idle mode, if a portion of the service flows exist in the idle mode and a remainder of the service flows exists in the active mode.

7. The method of claim 5, wherein performing the specific operation of the service flow comprises performing a Dynamic Service Addition operation or a Dynamic Service Change operation of the service flow.

8. The method of claim 6, wherein performing the specific operation of the service flow comprises performing a Dynamic Service Addition operation or a Dynamic Service Change operation of the service flow.

9. A system for transmitting/receiving data in a communication system, comprising:
a base station for detecting, if there is data to exchange with a mobile station, a service flow for transmission of the data, setting in a message an identifier of the detected service flow, transmitting the message to the mobile station, performing a paging operation of the service flow with the mobile station according to the transmitted message, and transmitting the data to the mobile station; and
the mobile station for receiving the message used for transmission of the data from the base station, performing a specific operation of the service flow with the base station according to the received message, and receiving the data.

10. The system of claim 9, wherein the base station further sets in the message a Media Access Control (MAC) address of the mobile station to which the base station will transmit the data.

11. The system of claim 9, wherein the base station detects operation modes of all service flows at a generation time of the data, and detects a service flow to exist in an active mode for transmission of the data among all the service flows.

12. The system of claim 11, wherein the base station sets in the message an identifier of a service flow to transition from an idle mode to the active mode for transmission of the data, if all the service flows exist in the idle mode.

13. The system of claim 11, wherein the base station sets in the message an identifier of a service flow to transition from an idle mode to the active mode, if a portion of the service flows exist in the idle mode and a remainder of the service flows exists in the active mode.

14. The system of claim 11, wherein the base station sets in the message an identifier of a service flow to transition from the active mode to an idle mode, if a portion of the service flows exist in the idle mode and a remainder of the service flows exists in the active mode.

15. The system of claim 13, wherein the base station performs a Dynamic Service Addition operation or a Dynamic Service Change operation with the mobile station according to the message.

16. The system of claim 14, wherein the base station performs a Dynamic Service Addition operation or a Dynamic Service Change operation with the mobile station according to the message.

17. The system of claim 9, wherein the mobile station performs a Dynamic Service Addition operation or a Dynamic Service Change operation with the base station, if the identifier of the detected service flow set in the message is an identifier of a service flow that should transition from an idle mode to an active mode for transmission of the data, or an identifier of a service flow that should transition from the active mode to the idle mode.

18. The system of claim 9, wherein the mobile station receives the message in which a Media Access Control (MAC) address of the mobile station is further set.
